(19) United States
(12) Patent Application Publication
(10) Pub. No.: US 2012/0045612 A1
(43) Pub. Date: Feb. 23, 2012

(54) PRESSURE-SENSITIVE ADHESIVE SHEET

(76) Inventors: Takashi Morioka, Tokyo (JP); Naoki Taya, Tokyo (JP)

(21) Appl. No.: 13/202,111

(22) PCT Filed: Jan. 27, 2010
(86) PCT No.: PCT/JP2010/051053

§ 371 Date: Oct. 4, 2011

(30) Foreign Application Priority Data
Mar. 2, 2009 (JP) 2009-047901

(51) Int. Cl. C09J 7/02

(52) U.S. Cl. 428/137

(57) ABSTRACT

A pressure-sensitive adhesive sheet is a laminate of a base material, a pressure-sensitive adhesive layer and a release material, and has a plurality of through-holes passing through from a surface of the base material to a pressure-sensitive adhesive face. The base material comprises a resin composition that contains 65 to 98 wt % of a polyolefin based resin (A) and 2.0 to 35 wt % of a pigment (B). In such a pressure-sensitive adhesive sheet, air entrapments and blisters can be prevented or removed by way of the through-holes. Also, expansion of the inner diameter of the through-holes is suppressed, and thereby the pressure-sensitive adhesive sheet has good appearance.

### TECHNICAL FIELD

The present invention relates to a pressure-sensitive adhesive sheet that allows preventing or removing, for instance, air entrapments and blisters.

### BACKGROUND ART

When a pressure-sensitive adhesive sheet is affixed manually onto an adherend, air entrapments may occur between the adherend and the pressure-sensitive adhesive face, thereby detracting from the appearance of the pressure-sensitive adhesive sheet. Such air entrapments occur readily, in particular, when the surface area of the pressure-sensitive adhesive sheet is large.

Also, resin materials such as acrylic resins, ABS resins, polystyrene resins, and polycarbonate resins may release gases, for instance when heated. When a pressure-sensitive adhesive sheet is affixed to an adherend formed of such resin materials, the gas released by the adherend may give rise to blisters in the pressure-sensitive adhesive sheet.

With a view to solving the above problems, a pressure-sensitive adhesive sheet has been proposed in which through-holes having a hole diameter of 0.1 to 300 μm and a hole density of 30 to 50,000 holes/100 cm² are formed (Patent document 1). Such a pressure-sensitive adhesive sheet allows preventing air entrapments and blisters in the pressure-sensitive adhesive sheet through allowing air and gas on the side of the pressure-sensitive adhesive face to escape towards the side of the surface of the pressure-sensitive adhesive sheet, via the through-holes.

In the pressure-sensitive adhesive sheet of Patent document 1, however, through-holes became visible to the naked eye in some instances depending on the hole diameter of the through-holes or on the material of the base material. Then, the appearance of the pressure-sensitive adhesive sheet was not necessarily good in some instances.

Therefore, a pressure-sensitive adhesive sheet has been proposed in which there is used a base material of which a surface roughness (Ra), a chroma (C*), a lightness (L*), and a contrast ratio are prescribed, and the hole diameters of through-holes in the base material and a pressure-sensitive adhesive layer, the hole diameter of the through-holes at the surface of the base material, the outside diameter of melted portions formed by the laser around the through-holes at the surface of the base material, and the outside diameter of thermally deformed portions formed by the laser around the through-holes or around the melted portions at the surface of the base material are also determined (Patent document 2). The appearance of such pressure-sensitive adhesive sheets is basically comparable to that of pressure-sensitive adhesive sheets having no through-holes.
Patent document 1: Domestic re-publication of PCT international publication 2004/061032
Patent document 2: Domestic re-publication of PCT international publication 2005/121268

### DISCLOSURE OF THE INVENTION

### Problem to be Solved by the Invention

Laser drilling is sometimes used to form through-holes in the above pressure-sensitive adhesive sheet. Among laser drilling processes, carbon dioxide laser processing differs from a laser ablation process in that the carbon dioxide laser processing is a so-called laser thermal processing that involves a decomposition process of materials by heat.

If the above-described laser thermal processing is performed on a base material in the form of a resin film formed of a polyolefin such as polyethylene or polypropylene, or a polyolefin based thermoplastic elastomer, then expansion of the inner diameter of the through-holes occurs due to melt of the material of the base material, when irradiated with a laser light, before the material scatters on account of the thermal decomposition of the material, since the material has a high thermal decomposition temperature but a low melting temperature. When the inner diameter of the through-holes becomes large in such a manner, the appearance of the pressure-sensitive adhesive sheet may be impaired due to sink at the periphery of the opening of the through-holes, or, in a case where the obtained pressure-sensitive adhesive sheet is affixed to an adherend and a liquid such as water or gasoline then contacts the affixed pressure-sensitive adhesive sheet, the appearance of the pressure-sensitive adhesive sheet may be deteriorated due to reasons such as intrusion of the liquid into the through-holes and resulting swelling of the portions of the through-holes (periphery of the through-holes).

In the pressure-sensitive adhesive sheet of Patent document 2 as well, the inner diameter of the through-holes expanded in some cases depending on the material of the base material, and there occurred problems such as the above-described ones occurred (in particular, base material of Example 16 in Patent document 2).

In the light of the above, it is an object of the present invention to provide a pressure-sensitive adhesive sheet in which air entrapments and blisters can be prevented or removed by way of through-holes and which has good appearance since expansion of the inner diameter of the through-holes is suppressed.

### Means for Solving the Problem

With a view to attaining the above object, the present invention provides a pressure-sensitive adhesive sheet comprising a base material and a pressure-sensitive adhesive layer, and having a plurality of through-holes passing through from one face to the other face thereof, wherein the base material comprises a resin composition containing 65 to 98 wt % of a polyolefin based resin (A) and 2.0 to 35 wt % of a pigment (B) (Invention 1).

In the present description, the term “sheet” includes conceptually films, and the term “film” includes conceptually sheets.

Through blending of the pigment (B) in an amount greater than ordinary blending amounts with respect to the polyolefin based resin (A), the above invention (Invention 1) elicits the advantageous effect of reducing thermal damage to a base material, and suppressing expansion of the inner diameter of through-holes, during formation of through-holes in the base material by thermal processing, in particular laser thermal processing, and more specifically carbon dioxide laser processing. The weatherability of the base material is enhanced, as a concomitant effect. Therefore, the above invention (Invention 1) affords a pressure-sensitive adhesive sheet in which air entrapments and blisters can be prevented or removed and in which expansion of the inner diameter of through-holes can be suppressed, even if the through-holes are formed by thermal processing such as laser thermal processing, and affords also a pressure-sensitive adhesive sheet having excellent weatherability.

In the above invention (Invention 1), preferably, the polyolefin based resin (A) is a polyolefin based resin including an ethylenic structure as a structural unit (Invention 2). In particular, the polyolefin based resin (A) is preferably a copolymer of ethylene and (meth)acrylic acid or a (meth)acrylate (Invention 3), and yet more preferably an ethylene-(meth)acrylic acid copolymer (Invention 4).

In the above inventions (Inventions 1 to 4), preferably, the pigment (B) has an absorption peak at a wavelength region of a carbon dioxide laser (Invention 5).

In the above inventions (Inventions 1 to 5), preferably, the pigment (B) is at least one type selected from the group of inorganic pigments (Invention 6).

In the above inventions (Inventions 1 to 6), preferably, the pigment (B) is carbon black (Invention 7).

In the above inventions (Inventions 1 to 7), preferably, the through-holes are formed by thermal processing (Invention 8).

In the above invention (Invention 8), preferably, the thermal processing is laser thermal processing (Invention 9).

In the above invention (Invention 9), preferably, the laser used in the laser thermal processing is a carbon dioxide laser (Invention 10).

In the above inventions (Inventions 1 to 10), preferably, the hole diameter of the through-holes at a surface of the base material is smaller than the hole diameter of the through-holes at a pressure-sensitive adhesive face of the pressure-sensitive adhesive layer (Invention 11).

### Advantageous Effect of the Invention

The present invention provides a pressure-sensitive adhesive sheet in which air entrapments and blisters can be prevented or removed and in which expansion of the inner diameter of through-holes can be suppressed even if the through-holes are formed by thermal processing such as laser thermal processing. In such a pressure-sensitive adhesive sheet it becomes possible to prevent impairment of the appearance of the pressure-sensitive adhesive sheet caused by sinking of the periphery of the openings of the through-holes. Even in a case where a liquid such as water and gasoline comes into contact with the pressure-sensitive adhesive sheet after the pressure-sensitive adhesive sheet is affixed to an adherend, it becomes possible to prevent deterioration of the appearance of the pressure-sensitive adhesive sheet caused by intrusion of the liquid into the through-holes and swelling of the portions of the through-holes (periphery of the through-holes).

### BRIEF DESCRIPTION OF THE DRAWINGS

FIG. 1 is a cross-sectional diagram of a pressure-sensitive adhesive sheet according to one embodiment of the present invention;

FIG. 2 is a partial enlarged cross-sectional diagram of a pressure-sensitive adhesive sheet, illustrating a through-hole having an expanded inner diameter; and

FIG. 3 is a cross-sectional diagram illustrating an example of a method for producing the pressure-sensitive adhesive sheet according to one embodiment of the present invention.

### MODE FOR CARRYING OUT THE INVENTION

Embodiments of the present invention are explained below.

[Pressure-Sensitive Adhesive Sheet]

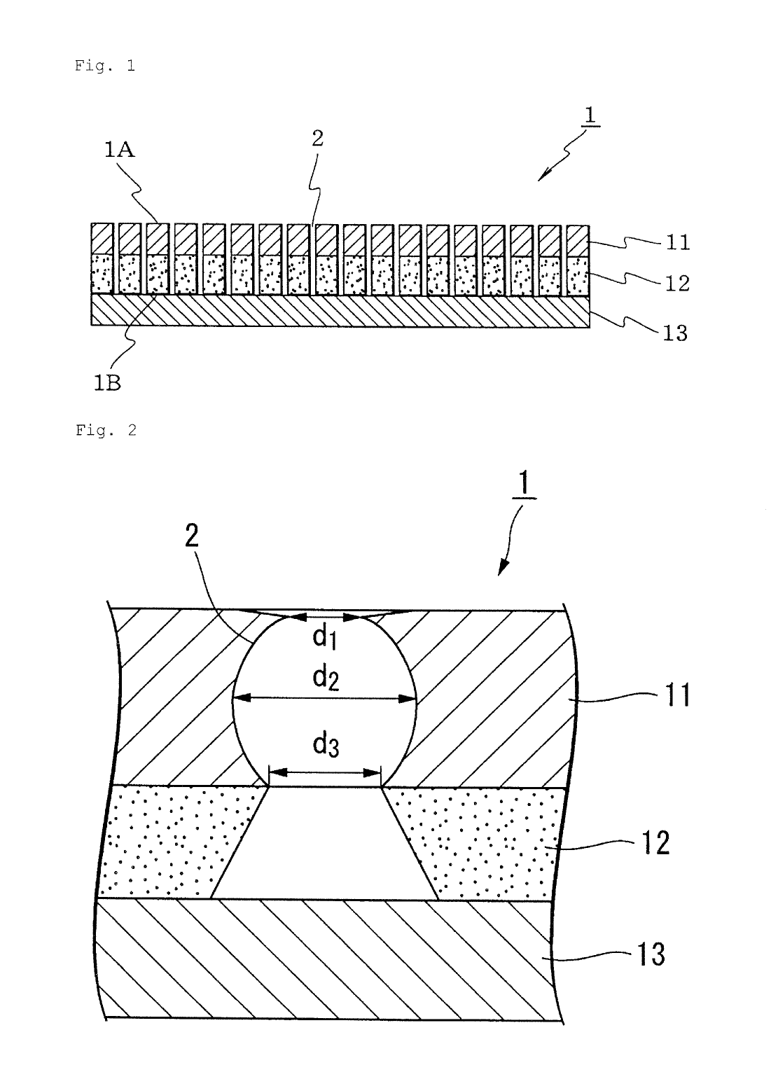

FIG. 1 is a cross-sectional diagram of a pressure-sensitive adhesive sheet according to one embodiment of the present invention.

As illustrated in FIG. 1, a pressure-sensitive adhesive sheet 1 according to the present embodiment is a laminate of a base material 11, a pressure-sensitive adhesive layer 12 and a release material 13. The release material 13 is removed during use of the pressure-sensitive adhesive sheet 1.

A plurality of through-holes 2 which pass through the base material 11 and the pressure-sensitive adhesive layer 12 from the surface of the base material 1A to a pressure-sensitive adhesive face 1B are formed in the pressure-sensitive adhesive sheet 1. During use of the pressure-sensitive adhesive sheet 1, air trapped between the pressure-sensitive adhesive face 1B of the pressure-sensitive adhesive layer 12 and the adherend, or gas generated by the adherend, are escaped via the through-holes 2 out of the base material surface 1A. Thereby, formation of air entrapments and blisters can be prevented, or formed air entrapments can be easily removed, as described below.

The base material 11 has a main layer formed of a resin film in the form of such as a film comprising a resin composition containing a polyolefin based resin (A) and a pigment (B), a foamed film, and a laminate film of the foregoing films.

As the polyolefin based resin (A) there may be selected any known polyolefin based resin. Examples include, for instance, homopolymers of α-olefins such as ethylene, propylene, butene-1,3-methylbutene-1,3-methylpentene-1,4-methylpentene-1, copolymers of the α-olefins, and copolymers of the α-olefins with other monomers. The foregoing polymers can be used singly or in blends of two or more polymers. Examples of other monomers in the above copolymers include, for instance, (meth)acrylic acid, (meth)acrylates, vinyl acetate, vinyl alcohol, and maleic anhydride.

Typical examples of the polyolefin based resin (A) include, for instance, high-density/medium-density/low-density polyethylene, linear low-density polyethylene, polypropylene, ethylene-(meth)acrylic acid copolymers, ethylene-alkyl (meth)acrylate copolymers, ethylene-vinyl acetate copolymers, ethylene-vinyl alcohol copolymers, ethylene-maleic anhydride copolymers, block copolymers and random copolymers of propylene and ethylene, propylene-ethylene-diene compound copolymers, polybutene-1, and poly(4-methylpentene-1). A polyolefin based resin including an ethylenic structure as a structural unit is preferred among the foregoing polymers. A copolymer of ethylene and (meth)acrylic acid or a (meth)acrylate is particularly preferred, and an ethylene-(meth)acrylic acid copolymer is yet more preferred. Using such preferred polyolefin based resins, in particular, an ethylene-(meth)acrylic acid copolymer, is advantageous in that the dispersibility of the pigment (B) is better, and that the pigment (B) is not shed readily out of a film formed of the resin composition even if the resin composition includes substantial amounts of the pigment (B).

Preferably, the polyolefin based resin (A) is a polyolefin based resin other than a polyolefin based thermoplastic elastomer. That is because polyolefin based thermoplastic elastomers have somewhat lower mechanical strength than other polyolefin based resins.

Preferably, the weight average molecular weight of the polyolefin based resin (A) ranges from 10,000 to 3,000,000, in particular from 50,000 to 500,000.

In light of the content of the below-described pigment (B), the content of polyolefin based resin (A) in the resin composition forming the base material 11 ranges from 65 to 98 wt %, preferably from 70 to 97.5 wt %.

In the present embodiment, the pigment (B) is blended in a greater amount than an ordinary blending amount with respect to the above polyolefin based resin (A). This elicits the advantageous effect of reducing thermal damage on the base material 11 and thereby suppressing expansion of the inner diameter of the through-holes 2, when the through-holes 2 are formed in the base material 11 by thermal processing, in particular laser thermal processing, and more specifically carbon dioxide laser processing. Also, the weatherability of the base material 11 is enhanced, as a concomitant effect.

Herein, expansion of the inner diameter of the through-holes 2 basically means, as illustrated in FIG. 2, that the largest diameter d₂ of the through-holes 2 in the base material 11 is greater than the diameter d₁ of the through-holes 2 at the surface of the base material 1A, and significantly larger than the diameter d₃ of the through-holes 2 at the interface between the base material 11 and the pressure-sensitive adhesive layer 12. However, expansion of the inner diameter is not necessarily limited to such conditions, and includes other instances in which the diameter of the through-holes 2 changes in such a way so as to give rise to the above-described problems. When the inner diameter of the through-holes 2 expands, the periphery of the opening of the through-holes 2 tends to sink according to the diameter d₂ of the through-holes 2 (FIG. 2).

The content of pigment (B) in the resin composition forming the base material 11 ranges from 2.0 to 35 wt %, preferably from 2.5 to 30 wt %. The above-described effect fails to be elicited if the content of the pigment (B) is smaller than 2.0 wt %. On the other hand, the mechanical strength of the base material 11, and thus of the pressure-sensitive adhesive sheet 1, is impaired if the content of pigment (B) exceeds 35 wt %.

A known pigment may be appropriately selected as the pigment (B). If the through-holes 2 are formed by laser processing, however, the pigment has preferably an absorption peak at the wavelength region of the laser that is used. In a case where, for instance, the through-holes 2 are formed by carbon dioxide laser, the pigment has preferably an absorption peak at the wavelength region (1087 to 962 cm⁻²) of the carbon dioxide laser. The through-holes 2 can be formed as a result at a low laser output.

The pigment may be an inorganic pigment or an organic pigment. Inorganic pigments are superior in weatherability and laser drilling properties. Therefore, the pigment (B) is preferably at least one type of pigment selected from the group consisting of inorganic pigments.

Examples of inorganic pigments include, for instance, carbon black, titanium black, anhydrous silica, magnesium silicate, talc, kaolin, bentonite, mica, titanium mica, bismuth oxychloride, zirconium oxide, magnesium oxide, zinc oxide, titanium oxide, light calcium carbonate, heavy calcium carbonate, light magnesium carbonate, heavy magnesium carbonate, yellow iron oxide, colcothar, black iron oxide, ultramarine, chromium oxide, chromium hydroxide, and calamine. Carbon black is particularly preferred among the foregoing inorganic pigments. Carbon black is particularly effective in preventing the above-described inner diameter expansion.

As is known, the highest blending amount of carbon black in a polyolefin film is 1.00% (“Carbon Black Handbook”, second edition, edited by CARBON BLACK ASSOCIATION, published by TOSHO SHUPPAN Co. Ltd., May 25, 1972, p. 361, Table 3-1). That is, the content of pigment (B) in the resin composition forming the base material 11 which is 2.0 wt % or higher, as described above, implies that the content of pigment (B) is twice or more the content according to common technical knowledge in the technical field. The blending amount of pigment in the black opaque base material formed of a polyolefin thermoplastic elastomer and used in Example 16 in Patent document 2 is unclear, but is thought to be no greater than 1.00 wt %.

The above resin film may be a resin film that includes various additives such as organic fillers, ultraviolet absorbents, and lubricants. The above resin film may be formed by casting or the like using a carrier sheet. Provided that the shape of the through-holes 2 is not negatively influenced, a decoration layer by a method such as printing, typing, painting of a painting material, transfer from a transfer sheet, vapor deposition, or sputtering; a coating layer such as an adhesion facilitating coat for forming the decoration layer or a gloss-adjusting coat; or a coating layer such as a hard coat, an antifouling coat, a coat for adjusting surface roughness and specular gross, and a coat for imparting weatherability may be formed on the surface of the above-described resin film. These decoration layers or coating layers may be formed over the entire surface of the above-described resin film, or may be formed on a part of the surface of the above-described resin film.

The thickness of the base material 11 ranges ordinarily from 1 to 500 μm, preferably from about 3 to 300 μm, but may vary appropriately in accordance with the use of the pressure-sensitive adhesive sheet 1.

The type of pressure-sensitive adhesive that makes up the pressure-sensitive adhesive layer 12 is not particularly limited, so long as the through-holes 2 can be formed, and may be an acrylic-based, polyester-based, polyurethane-based, rubber-based, or silicone-based resin. The pressure-sensitive adhesive may be of emulsion type, solvent type, or solventless type, and may be of crosslinking type or non-crosslinking type.

The thickness of the pressure-sensitive adhesive layer 12 ranges ordinarily from 1 to 300 μm, preferably from about 5 to 100 μm, but may vary appropriately in accordance with the use of the pressure-sensitive adhesive sheet 1.

The material of the release material 13 is not particularly limited, and may be obtained by treating the surface of a film or a paper with a release agent such as a silicone-based release agent, a fluorine-based release agent, and a release agent of a carbamate containing a long-chain alkyl group. The film may be formed of a resin such as polyethylene terephthalate, polypropylene or polyethylene, and a foamed film of the foregoing, and examples of the paper include glassine paper, coated paper, and laminated paper.

The thickness of the release material 13 ranges ordinarily from about 10 to 250 μm, preferably from about 20 to 200 μm. The thickness of the release agent in the release material 13 ranges ordinarily from 0.05 to 5 μm, preferably from 0.1 to 3 μm.

The hole diameter of the through-holes 2 ranges preferably from 0.1 to 300 μm, in particular, from 0.5 to 150 μm, throughout the base material 11 and the pressure-sensitive adhesive layer 12 (i.e. at all positions in the thickness direction of the base material 11 and the pressure-sensitive adhesive layer 12). If the hole diameter of the through-holes 2 is smaller than 0.1 μm, air or gas does not escape readily. If the hole diameter exceeds 300 μm, the through-holes 2 become conspicuous and hence the appearance of the pressure-sensitive adhesive sheet is marred. Also, the mechanical strength of the pressure-sensitive adhesive sheet 1 may be impaired if the hole diameter exceeds 300 μm. In particular, when the through-holes 2 is required not be visible at a very close range, the hole diameter at the surface 1A of the base material 11 ranges preferably from 0.1 to 40 μm.

The through-holes 2 are preferably formed by thermal processing. In particular, the through-holes 2 are preferably formed by laser thermal processing, yet more preferably by laser thermal processing using a carbon dioxide laser. When the through-holes 2 are formed in accordance with such a method, the above-described effect of preventing the expansion of the inner diameter can be distinctly exerted.

The hole density of the through-holes 2 is preferably 500 to 50,000 holes/100 cm², in particular of 1,000 to 10,000 holes/100 cm². If the hole density of the through-holes 2 is less than 500 holes/100 cm², air or gas may not readily escape. if the hole density of the through-holes 2 exceeds 50,000 holes/100 cm², the tensile strength and the tear strength of the pressure-sensitive adhesive sheet 1 may become impaired.

The through-holes 2 in the pressure-sensitive adhesive sheet 1 according to the present embodiment pass only through the base material 11 and the pressure-sensitive adhesive layer 12, but may pass through the release material 13 as well.

The pressure-sensitive adhesive sheet 1 according to the present embodiment comprises the release material 13, but the present invention is not limited thereto, and the release material 13 may be omitted. Also, the size, shape and so forth of the pressure-sensitive adhesive sheet 1 according to the present embodiment are not particularly limited. For instance, the pressure-sensitive adhesive sheet 1 may be a tape-like sheet (pressure-sensitive adhesive tape) comprising only the base material 11 and the pressure-sensitive adhesive layer 12, and may be wound up in the shape of a roll.

As described above, the through-holes 2 are formed in the pressure-sensitive adhesive sheet 1 in such a manner that expansion of the inner diameter of the through-holes 2 in the base material 11 is suppressed by virtue of the particular blending amount of the pigment (B). Therefore, it becomes possible to prevent the problems caused by expansion of the inner diameter of the through-holes 2, namely the problem of impairment of the appearance of the pressure-sensitive adhesive sheet 1 caused by sinking at the periphery of the openings of the through-holes 2, and the problem of deterioration of the appearance of the pressure-sensitive adhesive sheet 1, occurring in a case where a liquid such as water or gasoline comes into contact with the obtained pressure-sensitive adhesive sheet 1 after the obtained sheet is affixed to an adherend, caused by intrusion of the liquid into the through-holes 2 and swelling of the portions of the through-holes 2 (periphery of the through-holes 2).

[Manufacture of the Pressure-Sensitive Adhesive Sheet]

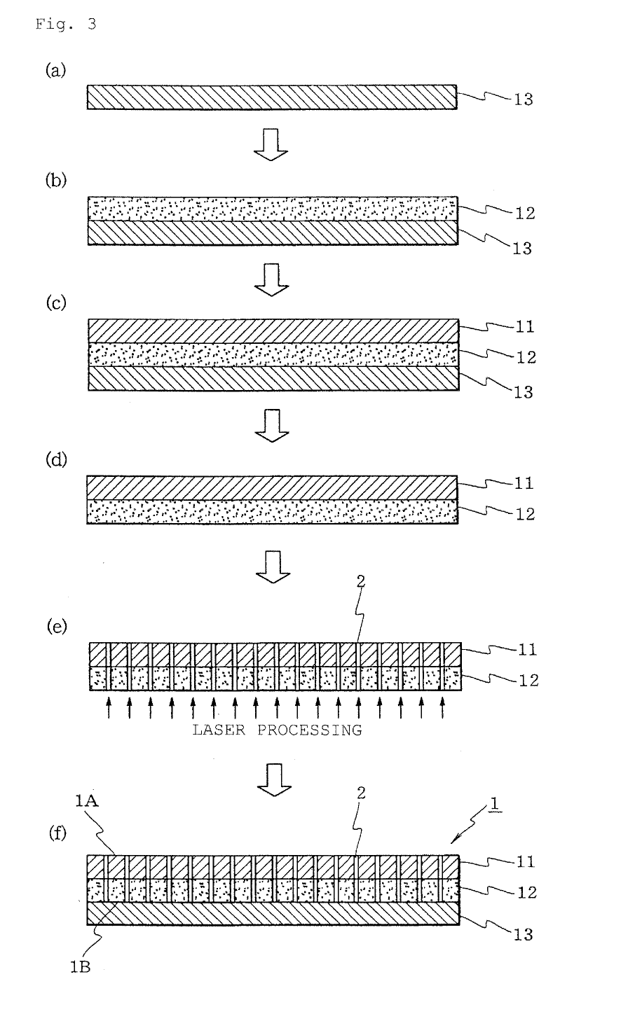

An example of the manufacturing method of the pressure-sensitive adhesive sheet 1 according to the above embodiment is explained next with reference to FIGS. 3(a) to (f).

In the present manufacturing method, firstly the pressure-sensitive adhesive layer 12 is formed on a release-treated surface of the release material 13, as illustrated in FIGS. 3(a) to (b). To form the pressure-sensitive adhesive layer 12, there may be prepared a coating agent which contains the pressure-sensitive adhesive forming the pressure-sensitive adhesive layer 12 and which may contain a solvent, as desired. The prepared coating agent may then be applied to the release-treated surface of the release material 13, using coating equipment such as a roll coater, a knife coater, a roll-knife coater, an air-knife coater, a die coater, a bar coater, a gravure coater, and a curtain coater, followed by drying.

Next, as illustrated in FIG. 3(c), the base material 11 is press-bonded to the surface of the pressure-sensitive adhesive layer 12, to yield a laminate comprising the base material 11, the pressure-sensitive adhesive layer 12, and the release material 13. The release material 13 is peeled off the pressure-sensitive adhesive layer 12, as illustrated in FIG. 3(d), after which the through-holes 2 are formed in the laminate comprising the base material 11 and the pressure-sensitive adhesive layer 12, as illustrated in FIG. 3(e). The release material 13 is then re-pressed again onto the pressure-sensitive adhesive layer 12, as illustrated in FIG. 3(f).

The through-holes 2 are formed by thermal processing. Types of thermal processing include, for instance, laser thermal processing, thermal processing by hot needle, and thermal processing by fusing perforation. Preferred among these is laser thermal processing, since laser thermal processing allows forming readily minute through-holes having good air-escaping ability and a desired hole density. The pressure-sensitive adhesive sheet 1 can have good appearance even if the through-holes 2 are formed by such thermal processing, since expansion of the inner diameter of the through-holes 2 is suppressed and fusion products are not readily formed.

Types of laser that are used in laser thermal processing include, for instance, a carbon dioxide (CO₂) laser, a TEA-CO₂ laser, a YAG laser, a UV-YAG laser, a YVO₄ laser, and a YLF laser. Preferred among the foregoing lasers is a carbon dioxide laser, in terms of, for instance, production efficiency and cost.

The process for forming the through-holes 2 using laser thermal processing may involve a burst process (burst mode) in which laser light is continuously irradiated onto one site until formation of one through-hole 2, or a cycle process (cycle mode) in which a plurality of through-holes 2 are uniformly formed through sequential irradiation of laser light onto a plurality of sites. The former process is superior as regards thermal efficiency, while the latter process is better at reducing thermal impact on the object to be processed. Either process may be used in the above laser thermal processing.

When carrying out laser thermal processing, laser light is preferably irradiated so that the irradiated laser light travels from the side of the pressure-sensitive adhesive layer 12 towards the base material 11. By virtue of performing laser thermal processing from the side of the pressure-sensitive adhesive layer 12, the hole diameter of the through-holes 2 at the surface of the base material surface 1A becomes smaller than the hole diameter at the pressure-sensitive adhesive face 1B of the pressure-sensitive adhesive layer 12. Also, irradiation of laser light directly onto the pressure-sensitive adhesive layer 12 after temporarily peeling the release material 13 can reduce the output energy of the laser. Reducing the output energy of the laser allows forming neatly shaped through-holes 2 with little fusion material and few thermally deformed sites that result from the heat.

Fusion materials are not readily formed at the peripheral edge of the opening of the through-holes 2 even by laser thermal processing. Even if fusion materials adhere, a protective film previously affixed onto the surface of the base material 11 can prevent fusion materials from adhering onto the surface of the base material 11. As the protective film there can be used a known protective film that is utilized in construction materials or metal sheets. If the base material 11 is produced by casting, then laser thermal processing may be performed in a state in which a carrier sheet for casting is laminated onto the surface of the base material 11.

In the above production method, the pressure-sensitive adhesive layer 12 is coated onto the release material 13, and the formed pressure-sensitive adhesive layer 12 and the base material 11 are then press-bonded together. However, the present invention is not limited thereto, and the pressure-sensitive adhesive layer 12 may be formed directly on the base material 11.

[Use of the Pressure-Sensitive Adhesive Sheet]

To affix the pressure-sensitive adhesive sheet 1 to an adherend, firstly the release material 13 is removed the pressure-sensitive adhesive layer 12.

Next, the pressure-sensitive adhesive sheet 1 is pressed against the adherend so that the exposed pressure-sensitive adhesive face 1B of the pressure-sensitive adhesive layer 12 is brought into close contact with the adherend. At this time, the air between the pressure-sensitive adhesive face 1B of the pressure-sensitive adhesive layer 12 and the adherend is escaped out of the surface of the base material 1A via the through-holes 2 formed in the pressure-sensitive adhesive sheet 1. This makes entrapment of air between the pressure-sensitive adhesive face 1B and the adherend less likely, and hence formation of air entrapments is prevented. Even if air entrapments are formed due to the entrapment of air, re-pressing the air entrapment portions or air entrapment peripheral portions that encompass the air entrapment portions enables the air to escape out of the surface of the base material 1A via the through-holes 2, and hence such air entrapments are removed. Such removal of air entrapments is also possible long after the pressure-sensitive adhesive sheet 1 has been affixed.

Even if the adherend releases a gas after the pressure-sensitive adhesive sheet 1 has been affixed to the adherend, such gas can escape out of the surface of the base material 1A via the through-holes 2 formed in the pressure-sensitive adhesive sheet 1. Accordingly, formation of blisters in the pressure-sensitive adhesive sheet 1 is prevented.

### EXAMPLES

The present invention is explained in detail below based on examples. However, the invention is in no way meant to be limited to or by the examples.

### Example 1

Kneaded pellets were prepared out of a mixture of 90 wt % of an ethylene-methacrylic acid copolymer (NUCREL N0903HC, by DU PONT-MITSUI POLYCHEMICALS Co., Ltd.) and 10 wt % of carbon black (SUNBLACK 200, by ASAHI CARBON Co., Ltd.), in a twin-screw extrusion kneader (KZW25TWIN-30MG-STM, by TECHNOVEL Corp.). A film 100 μm thick was then prepared from the above-described kneaded pellets, using an extrusion tester (LABOPLAST MILL 30C150, by Toyo Seiki Seisaku-Sho, Ltd.). The obtained film was used as a base material of pressure-sensitive adhesive sheets.

A coating agent of an acrylic based solvent-type pressure-sensitive adhesive (PK, by LINTEC Corporation) was applied with a knife coater, to a thickness after drying of 30 μm, onto the release-treated surface of a release material (FPM-11, thickness: 175 μm, by LINTEC Corporation), which was obtained by laminating a polyethylene resin onto both faces of woodfree paper followed by release treatment of one face of the resultant laminate using a silicone-based release agent. The whole was then dried at 90° C. for 1 minute. The above-described film as the base material was press-bonded to the pressure-sensitive adhesive layer thus formed. Onto the surface of the base material there was superposed also a protective sheet (E-2035, thickness: 60 μm, by SUMIRON Co., Ltd.) having a removable pressure-sensitive adhesive layer, to yield a laminate having a 4-layer structure.

The release material was peeled off from the laminate, and the residual laminate was irradiated with a carbon dioxide laser (YB-HCS03, by Panasonic Corporation, two-shot burst process, frequency: 10,000 Hz, pulse width: 25 μsec (first shot)/12 μsec (second shot)), from the side of the pressure-sensitive adhesive layer, to form through-holes at a hole density of 2,500 holes/100 cm². Next, the above-described release material was press-bonded again onto the pressure-sensitive adhesive layer, and the protective sheet was peeled from the surface of the base material, to yield a pressure-sensitive adhesive sheet.

### Example 2

Kneaded pellets were prepared out of a mixture of 95 wt % of an ethylene-methacrylic acid copolymer (NUCREL N0903HC, by DU PONT-MITSUI POLYCHEMICALS Co., Ltd.) and 5 wt % of carbon black (SUNBLACK 200, by ASAHI CARBON Co., Ltd.), in a twin-screw extrusion kneader (KZW25TWIN-30MG-STM, by TECHNOVEL Corp.). A pressure-sensitive adhesive sheet was produced in the same way as in Example 1, except that these kneaded pellets were used herein.

### Example 3

Kneaded pellets were prepared out of a mixture of 97.5 wt % of an ethylene-methacrylic acid copolymer (NUCREL N0903HC, by DU PONT-MITSUI POLYCHEMICALS Co., Ltd.) and 2.5 wt % of carbon black (SUNBLACK 200, by ASAHI CARBON Co., Ltd.), in a twin-screw extrusion kneader (KZW25TWIN-30MG-STM, by TECHNOVEL Corp.). A pressure-sensitive adhesive sheet was produced in the same way as in Example 1, except that these kneaded pellets were used herein.

### Example 4

Kneaded pellets were prepared out of a mixture of 90 wt % of low-density polyethylene which used a metallocene catalyst (SUMIKATHENE EP GT050, by Sumitomo Chemical Co., Ltd.) and 10 wt % of carbon black (SUNBLACK 200, by ASAHI CARBON Co., Ltd.), in a twin-screw extrusion kneader (KZW25TWIN-30MG-STM, by TECHNOVEL Corp.). A pressure-sensitive adhesive sheet was produced in the same way as in Example 1, except that these kneaded pellets were used herein.

### Example 5

Kneaded pellets were prepared out of a mixture of 95 wt % of low-density polyethylene which used a metallocene catalyst (SUMIKATHENE EP GT050, by SUMITOMO CHEMICAL Co., Ltd.) and 5 wt % of carbon black (SUNBLACK 200, by ASAHI CARBON Co., Ltd.), in a twin-screw extrusion kneader (KZW25TWIN-30MG-STM, by TECHNOVEL Corp.). A pressure-sensitive adhesive sheet was produced in the same way as in Example 1, except that these kneaded pellets were used herein.

### Example 6

Kneaded pellets were prepared out of a mixture of 97.5 wt % of low-density polyethylene which used a metallocene catalyst (SUMIKATHENE EP GT050, by SUMITOMO CHEMICAL Co., Ltd.) and 2.5 wt % of carbon black (SUNBLACK 200, by ASAHI CARBON Co., Ltd.), in a twin-screw extrusion kneader (KZW25TWIN-30MG-STM, by TECHNOVEL Corp.). A pressure-sensitive adhesive sheet was produced in the same way as in Example 1, except that these kneaded pellets were used herein.

### Example 7

Kneaded pellets were prepared out of a mixture of 90 wt % of an ethylene-methyl methacrylate copolymer (ACRYFT WD301, by SUMITOMO CHEMICAL Co., Ltd.), and 10 wt % of carbon black (SUNBLACK 200, by ASAHI CARBON Co., Ltd.), in a twin-screw extrusion kneader (KZW25TWIN-30MG-STM, by TECHNOVEL Corp.). A pressure-sensitive adhesive sheet was produced in the same way as in Example 1, except that these kneaded pellets were used herein.

### Example 8

Kneaded pellets were prepared out of a mixture of 95 wt % of an ethylene-methyl methacrylate copolymer (ACRYFT WD301, by SUMITOMO CHEMICAL Co., Ltd.), and 5 wt % of carbon black (SUNBLACK 200, by ASAHI CARBON Co., Ltd.), in a twin-screw extrusion kneader (KZW25TWIN-30MG-STM, by TECHNOVEL Corp.). A pressure-sensitive adhesive sheet was produced in the same way as in Example 1, except that these kneaded pellets were used herein.

### Example 9

Kneaded pellets were prepared out of a mixture of 97.5 wt % of an ethylene-methyl methacrylate copolymer (ACRYFT WD301, by SUMITOMO CHEMICAL Co., Ltd.), and 2.5 wt % of carbon black (SUNBLACK 200, by ASAHI CARBON Co., Ltd.), in a twin-screw extrusion kneader (KZW25TWIN-30MG-STM, by TECHNOVEL Corp.). A pressure-sensitive adhesive sheet was produced in the same way as in Example 1, except that these kneaded pellets were used herein.

### Example 10

Kneaded pellets were prepared out of a mixture of 70 wt % of an ethylene-methacrylic acid copolymer (NUCREL N0903HC, by DU PONT-MITSUI POLYCHEMICALS Co., Ltd.) and 30 wt % of carbon black (SUNBLACK 200, by ASAHI CARBON Co., Ltd.), in a twin-screw extrusion kneader (KZW25TWIN-30MG-STM, by TECHNOVEL Corp.). A pressure-sensitive adhesive sheet was produced in the same way as in Example 1, except that these kneaded pellets were used herein.

### Example 11

Kneaded pellets were prepared out of a mixture of 90 wt % of an olefinic thermoplastic elastomer (ESPOLEX TPE4855, by SUMITOMO CHEMICAL Co., Ltd.), and 10 wt % of carbon black (SUNBLACK 200, by ASAHI CARBON Co., Ltd.), in a twin-screw extrusion kneader (KZW25TWIN-30MG-STM, by TECHNOVEL Corp,). A pressure-sensitive adhesive sheet was produced in the same way as in Example 1, except that these kneaded pellets were used herein.

### Example 12

Kneaded pellets were prepared out of a mixture of 95 wt % of an olefinic thermoplastic elastomer (ESPOLEX TPE4855, by SUMITOMO CHEMICAL Co., Ltd.), and 5 wt % of carbon black (SUNBLACK 200, by ASAHI CARBON Co., Ltd.), in a twin-screw extrusion kneader (KZW25TWIN-30MG-STM, by TECHNOVEL Corp,). A pressure-sensitive adhesive sheet was produced in the same way as in Example 1, except that these kneaded pellets were used herein.

### Example 13

Kneaded pellets were prepared out of a mixture of 97.5 wt % of an olefinic thermoplastic elastomer (ESPOLEX TPE4855, by SUMITOMO CHEMICAL Co., Ltd.), and 2.5 wt % of carbon black (SUNBLACK 200, by ASAHI CARBON Co., Ltd.), in a twin-screw extrusion kneader (KZW25TWIN-30MG-STM, by TECHNOVEL Corp,). A pressure-sensitive adhesive sheet was produced in the same way as in Example 1, except that these kneaded pellets were used herein.

### Comparative Example 1

Kneaded pellets were prepared out of a mixture of 60 wt % of an ethylene-methacrylic acid copolymer (NUCREL N0903HC, by DU PONT-MITSUI POLYCHEMICALS Co., Ltd.) and 40 wt % of carbon black (SUNBLACK 200, by ASAHI CARBON Co., Ltd.), in a twin-screw extrusion kneader (KZW25TWIN-30MG-STM, by TECHNOVEL Corp.). A pressure-sensitive adhesive sheet was produced in the same way as in Example 1, except that these kneaded pellets were used herein.

### Comparative Example 2

Kneaded pellets were prepared out of a mixture of 99 wt % of an ethylene-methacrylic acid copolymer (NUCREL N0903HC, by DU PONT-MITSUI POLYCHEMICALS Co., Ltd.) and 1 wt % of carbon black (SUNBLACK 200, by ASAHI CARBON Co., Ltd.), in a twin-screw extrusion kneader (KZW25TWIN-30MG-STM, by TECHNOVEL Corp.). A pressure-sensitive adhesive sheet was produced in the same way as in Example 1, except that these kneaded pellets were used herein.

### Comparative Example 3

A pressure-sensitive adhesive sheet was produced in the same way as in Example 1, but without using herein the carbon black of Example 1.

### Comparative Example 4

A pressure-sensitive adhesive sheet was produced in the same way as in Example 4, but without using herein the carbon black of Example 4.

### Comparative Example 5

A pressure-sensitive adhesive sheet was produced in the same way as in Example 7, but without using herein the carbon black of Example 7.

### Comparative Example 6

Kneaded pellets were prepared out of a mixture of 99 wt % of an olefinic thermoplastic elastomer (ESPOLEX TPE4855, by SUMITOMO CHEMICAL Co., Ltd.), and 1 wt % of carbon black (SUNBLACK 200, by ASAHI CARBON Co., Ltd.), in a twin-screw extrusion kneader (KZW25TWIN-30MG-STM, by TECHNOVEL Corp,). A pressure-sensitive adhesive sheet was produced in the same way as in Example 1, except that these kneaded pellets were used herein.

### Comparative Example 7

A pressure-sensitive adhesive sheet was produced in the same way as in Example 11, but without using herein the carbon black of Example 11.

### Test Examples

(1) Observation of Through-Hole Shape

The pressure-sensitive adhesive sheets obtained in the examples and comparative examples were cut at portions of the through-holes. The diameter of the through-holes at the surface of the base material, the largest diameter in the base material, the diameter at the interface between the base material and the pressure-sensitive adhesive layer, as well as the diameter at the pressure-sensitive adhesive face, were all measured using a digital microscope (VHX-200, manufactured by KEYENCE Corporation). The number of through-holes per 100 cm² was counted. The results are given in Table 1.

(2) Infrared Spectrophotometry

The base materials used in the examples and comparative examples were measured by universal ATR, using a Fourier transform infrared spectrophotometer (FT-IR SPECTRUM ONE, by Perkin Elmer Inc.), to check the presence of absorption peaks (FT-IR absorption peaks) at the wavelength region (1087 to 962 cm⁻¹) of the laser that was used. The results are given in Table 1. In table 1, ◯ (good) denotes absorption and x (poor) denotes absence of absorption.

(3) Measurement of Total Luminous Transmittance

The total luminous transmittance (%) of the base materials used in the examples and the comparative examples were measured in accordance with JIS K 7361 using a haze meter (NDH5000, by NIPPON DENSHOKU INDUSTRIES Co., Ltd.). The results are given in Table 1.

(4) Appearance Inspection

The appearance of the pressure-sensitive adhesive sheets obtained in the examples and comparative examples was inspected as described below. The results are given in Table 2.

Each pressure-sensitive adhesive sheet (size: 30 mm×30 mm), from which the release material had been removed, was affixed to a melamine-coated steel plate, and the appearance of the surface of the pressure-sensitive adhesive sheet was inspected with the naked eye under indoor fluorescent lighting. The distance from the eyes to the pressure-sensitive adhesive sheet was set at approximately 30 cm, and the angle from which the pressure-sensitive adhesive sheet was viewed was changed in various ways. ◯ (good) denotes a case where through-holes were invisible to the naked eye and x (poor) denotes a case where through-holes were visible to the naked eye.

(5) Weatherability Test

The pressure-sensitive adhesive sheets obtained in the examples and comparative examples were subjected to a weatherability test as described below. The results are given in Table 2.

Each pressure-sensitive adhesive sheet (size: 50 mm×50 mm), from which the release material had been removed, was affixed to a melamine coated plate. By using a Sunshine Weather Meter (S80, by Suga Test Instruments Co., Ltd.), the pressure-sensitive adhesive sheet was tested for 2000 hours under conditions of a temperature of the black panel of 63° C., a temperature and humidity of the chamber of 43° C. and 50% RH, an irradiance of 60 W/m², and a cycle of rainfall 18 minutes/120 minutes. The appearance of the surface of the pressure-sensitive adhesive sheet after the test was visually inspected. Absence of anomalies (cracking, whitening, and the like) in the appearance was rated as ◯ (good), while samples in which abnormalities in the appearance were observed were rated as x (poor).

(6) Air-Entrapment Removability Test 1

The pressure-sensitive adhesive sheets obtained in the examples and comparative examples were subjected to an air entrapment removability test as described below. The results are given in Table 2.

Each pressure-sensitive adhesive sheet (size: 50 mm×50 mm), having the release material removed therefrom, was affixed to a flat melamine-coated plate in such a manner that there were formed air entrapments having a diameter of about 15 mm. The pressure-sensitive adhesive sheet was press-bonded using a squeegee, and then it was checked whether the air entrapments could be removed or not. In the results, ◯ (good) denotes cases in which air entrapments were removed, while x (poor) denotes cases in which air entrapments were not removed (including cases with residual air entrapments however small).

(7) Air-Entrapment Removability Test 2

The pressure-sensitive adhesive sheets obtained in the examples and comparative examples were subjected to an air entrapment removability test as described below. The results are given in Table 2.

Each pressure-sensitive adhesive sheet (size: 50 mm×50 mm), having the release material removed therefrom, was affixed to a 70 mm×70 mm melamine-coated plate having partially spherical depressions (recesses) having a diameter of 15 mm and a maximum depth of 1 mm (so as to give rise to air entrapments between the depressions and the pressure-sensitive adhesive sheet). The pressure-sensitive adhesive sheet was press-bonded using a squeegee, and then it was checked whether the air entrapments could be removed or not. In the results, ◯ (good) denotes cases in which air entrapments were removed as the pressure-sensitive adhesive sheet hugged the depressions of the melamine-coated plate, while x (poor) denotes cases in which air entrapments could not be removed as the pressure-sensitive adhesive sheet failed to hug the depressions of the melamine-coated plate (including cases with residual air entrapments however small).

(8) Measurement of Breaking Strength

The base materials used in the examples and comparative examples were measured for breaking strength (MPa) according to JIS K 7127, using a precision universal tester (AUTOGRAPH AG-IS, by SHIMADZU Corporation). Breaking strength was measured in the machine direction (MD) and in the cross-machine direction (CD) of each base material. The results are given in Table 2.

TABLE 1

| | Through-hole diameter (μm) | | | | | | |
|---|---|---|---|---|---|---|---|
| | | Base | | Pressure- | Number of | Presence or | Total |
| | Base | material | | sensitive | through- | absence of | luminous |
| | material | largest | | adhesive | holes | FT-IR absorption | transmittance |
| | surface | diameter | Interface | face | (hole/100 cm²) | peaks | (%) |
| Example 1 | 25 to 30 | 75 | 65 to 75 | 65 to 75 | 2500 | ◯ | 0.0 |
| Example 2 | 25 to 30 | 70 | 65 to 70 | 65 to 75 | 2500 | ◯ | 0.0 |
| Example 3 | 25 to 30 | 65 | 60 to 65 | 65 to 75 | 2500 | ◯ | 0.0 |
| Example 4 | 25 to 30 | 70 | 65 to 70 | 65 to 75 | 2500 | ◯ | 0.0 |
| Example 5 | 25 to 30 | 70 | 60 to 70 | 65 to 75 | 2500 | ◯ | 0.0 |
| Example 6 | 20 to 25 | 70 | 65 to 70 | 65 to 75 | 2486 | ◯ | 0.0 |
| Example 7 | 25 to 30 | 70 | 65 to 70 | 65 to 75 | 2500 | ◯ | 0.0 |
| Example 8 | 25 to 30 | 70 | 65 to 70 | 65 to 75 | 2500 | ◯ | 0.0 |
| Example 9 | 25 to 30 | 70 | 65 to 70 | 65 to 75 | 2500 | ◯ | 0.0 |
| Example 10 | 30 to 40 | 75 | 70 to 75 | 65 to 75 | 2500 | ◯ | 0.0 |
| Example 11 | 25 to 30 | 70 | 65 to 70 | 65 to 75 | 2500 | ◯ | 0.0 |
| Example 12 | 25 to 30 | 70 | 65 to 70 | 65 to 75 | 2450 | ◯ | 0.0 |
| Example 13 | 25 to 30 | 75 | 70 to 75 | 65 to 75 | 2240 | ◯ | 0.0 |
| Comparative | 35 to 45 | 85 | 65 to 85 | 65 to 75 | 2500 | ◯ | 0.0 |
| example 1 | | | | | | | |
| Comparative | 25 to 30 | 85 | 60 to 70 | 65 to 75 | 970 | ◯ | 0.0 |
| example 2 | | | | | | | |
| Comparative | — | 90 | 70 to 80 | 65 to 75 | 0 | X | 89.3 |
| example 3 | | | | | | | |
| Comparative | — | 95 | 70 to 80 | 65 to 75 | 0 | X | 84.7 |
| example 4 | | | | | | | |
| Comparative | — | 95 | 70 to 80 | 65 to 75 | 0 | X | 88.5 |
| example 5 | | | | | | | |
| Comparative | 20 to 25 | 90 | 70 to 80 | 65 to 75 | 880 | ◯ | 0.0 |
| example 6 | | | | | | | |
| Comparative | — | 90 | 70 to 80 | 65 to 75 | 0 | X | 83.9 |
| example 7 | | | | | | | |

* “—” indicates that no through-holes were formed.

TABLE 2

| | | | | | Breaking | |
|---|---|---|---|---|---|---|
| | | | | | strength | |
| | Appearance | | Air-entrapment | Air-entrapment | (MPa) | |
| | inspection | Weatherability | removability 1 | removability 2 | MD | CD |
| Example 1 | ◯ | ◯ | ◯ | ◯ | 27.9 | 21.6 |
| Example 2 | ◯ | ◯ | ◯ | ◯ | 31.0 | 24.8 |
| Example 3 | ◯ | ◯ | ◯ | ◯ | 35.4 | 29.6 |
| Example 4 | ◯ | ◯ | ◯ | ◯ | 22.2 | 20.7 |
| Example 5 | ◯ | ◯ | ◯ | ◯ | 26.3 | 22.5 |
| Example 6 | ◯ | ◯ | ◯ | ◯ | 27.3 | 23.8 |
| Example 7 | ◯ | ◯ | ◯ | ◯ | 22.8 | 15.9 |
| Example 8 | ◯ | ◯ | ◯ | ◯ | 24.3 | 18.8 |
| Example 9 | ◯ | ◯ | ◯ | ◯ | 26.7 | 21.9 |
| Example 10 | ◯ | ◯ | ◯ | ◯ | 13.8 | 11.6 |
| Example 11 | ◯ | ◯ | ◯ | ◯ | 10.2 | 8.7 |
| Example 12 | ◯ | ◯ | ◯ | ◯ | 11.1 | 8.9 |
| Example 13 | ◯ | ◯ | ◯ | ◯ | 12.5 | 9.6 |
| Comparative | ◯ | ◯ | ◯ | ◯ | 6.5 | 4.7 |
| example 1 | | | | | | |
| Comparative | ◯ | X | ◯ | X | 36.3 | 31.7 |
| example 2 | | | | | | |
| Comparative | — | X | X | X | 28.8 | 26.9 |
| example 3 | | | | | | |
| Comparative | — | X | X | X | 24.3 | 22.6 |
| example 4 | | | | | | |
| Comparative | — | X | X | X | 20.1 | 17.6 |
| example 5 | | | | | | |
| Comparative | ◯ | X | ◯ | X | 12.4 | 9.5 |
| example 6 | | | | | | |
| Comparative | — | X | X | X | 9.8 | 8.1 |
| example 7 | | | | | | |

* “—” indicates that no through-holes were formed.

As Table 1 and Table 2 show, the pressure-sensitive adhesive sheets (Examples 1 to 10) that used a base material meeting the conditions of the present invention exhibited superior air-escaping ability, and exhibited a good appearance, with through-holes invisible to the naked eye and with no expansion of the inner diameter. The pressure-sensitive adhesive sheets also exhibited excellent weatherability and mechanical strength.

### INDUSTRIAL APPLICABILITY

The pressure-sensitive adhesive sheet of the present invention can be preferably used in cases where good appearance is required or weatherability is additionally required, not only under ordinary environments but also under environments in which a liquid such as gasoline comes into contact with the pressure-sensitive adhesive sheet, even when air entrapments or blisters are ordinarily likely to occur in the pressure-sensitive adhesive sheet, for example, when the surface area of the pressure-sensitive adhesive sheet is large or when a gas is released by the adherend.

### EXPLANATION OF REFERENCE NUMERALS

1 . . . pressure-sensitive adhesive sheet
   11 . . . base material
   12 . . . pressure-sensitive adhesive layer
   13 . . . release material
1A . . . surface of base material
1B . . . pressure-sensitive adhesive face
2 . . . through-hole

1. A pressure-sensitive adhesive sheet, comprising a base material and a pressure-sensitive adhesive layer, and having a plurality of through-holes passing through from one face to the other face thereof,
wherein the base material comprises a resin composition containing 65 to 98 wt % of a polyolefin based resin (A) and 2.0 to 35 wt % of a pigment (B).

2. The pressure-sensitive adhesive sheet according to claim 1, wherein the polyolefin based resin (A) is a polyolefin based resin including an ethylenic structure as a structural unit.

3. The pressure-sensitive adhesive sheet according to claim 1, wherein the polyolefin based resin (A) is a copolymer of ethylene and (meth)acrylic acid or a (meth)acrylate.

4. The pressure-sensitive adhesive sheet according to claim 1, wherein the polyolefin based resin (A) is an ethylene-(meth)acrylic acid copolymer.

5. The pressure-sensitive adhesive sheet according to claim 1, wherein the pigment (B) has an absorption peak at a wavelength region of a carbon dioxide laser.

6. The pressure-sensitive adhesive sheet according to claim 1, wherein the pigment (B) is at least one type selected from the group of inorganic pigments.

7. The pressure-sensitive adhesive sheet according to claim 1, wherein the pigment (B) is carbon black.

8. The pressure-sensitive adhesive sheet according to claim 1, wherein the through-holes are formed by thermal processing.

9. The pressure-sensitive adhesive sheet according to claim 8, wherein the thermal processing is laser thermal processing.

10. The pressure-sensitive adhesive sheet according to claim 9, wherein the laser used in the laser thermal processing is a carbon dioxide laser.

11. The pressure-sensitive adhesive sheet according to claim 1, wherein the hole diameter of the through-holes at a surface of the base material is smaller than the hole diameter of the through-holes at a pressure-sensitive adhesive face of the pressure-sensitive adhesive layer.

12. The pressure-sensitive adhesive sheet according to claim 2, wherein the pigment (B) has an absorption peak at a wavelength region of a carbon dioxide laser.

13. The pressure-sensitive adhesive sheet according to claim 3, wherein the pigment (B) has an absorption peak at a wavelength region of a carbon dioxide laser.

14. The pressure-sensitive adhesive sheet according to claim 4, wherein the pigment (B) has an absorption peak at a wavelength region of a carbon dioxide laser.

15. The pressure-sensitive adhesive sheet according to claim 2, wherein the pigment (B) is at least one type selected from the group of inorganic pigments.

16. The pressure-sensitive adhesive sheet according to claim 3, wherein the pigment (B) is at least one type selected from the group of inorganic pigments.

17. The pressure-sensitive adhesive sheet according to claim 4, wherein the pigment (B) is at least one type selected from the group of inorganic pigments.

18. The pressure-sensitive adhesive sheet according to claim 2, wherein the pigment (B) is carbon black.

19. The pressure-sensitive adhesive sheet according to claim 3, wherein the pigment (B) is carbon black.

20. The pressure-sensitive adhesive sheet according to claim 4, wherein the pigment (B) is carbon black.
